(19) United States
(12) Patent Application Publication
(10) Pub. No.: US 2008/0000426 A1
(43) Pub. Date: Jan. 3, 2008

(54) Device, system and method of non-invasive diagnosis of mastitis in a dairy cow

(76) Inventors: James R. Grabek, Minneapolis, MN (US); Michael Hoey, Shoreview, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 11/811,783

(22) Filed: Jun. 12, 2007

Related U.S. Application Data
(60) Provisional application No. 60/812,855, filed on Jun. 12, 2006.

(51) Int. Cl. A01J 5/013

(52) U.S. Cl. 119/14.14; 119/14.16; 702/19; 901/30

(57) ABSTRACT

A device, system, and method employ spectrometry to interrogate udder tissue or milk to diagnose clinical and sub-clinical mastitis.

### RELATED APPLICATIONS

This application claims the benefit of USSN 60/812,855, filed Jun. 12, 2006, which is herein incorporated by reference in its entirety.

### FIELD OF THE INVENTION

The present invention relates generally to a device, system and method of diagnosing mastitis in a dairy cow in a non-invasive manner.

### BACKGROUND OF THE INVENTION

Mastitis is an infection of a cow's mammary glands that can be caused by either contagious microorganisms or the environment. In the United States, the more common cause is environmental. In Europe, the more common cause is contagion. Mastitis has a significant economic impact. In the U.S., mastitis results in a $2 billion annual cost in lost milk production, decreased quality of milk premiums, veterinarian costs, drug treatment costs, additional herd management costs, decreased milk shelf life costs, and other costs. It is estimated that the per-cow cost of an episode of mastitis is $150-300.

Environmental mastitis is most often caused by the E Coli (Escherichius Coli) bacteria and is often associated with fecal material (manure). Most environmental mastitis could be prevented with diligent cleaning of cow teats, especially prior to the milking process. If a teat has contaminants (fecal matter) when the milking machine cups are engaged, there is an opportunity for bacteria in the contaminants to make their way into the mammary gland through the teat's orifice. This is facilitated by the action of the milking machine. When the pulse of suction creates a vacuum surrounding the cow's teat, there can be a leak at the contact area, often due to the teat not being clean. This can allow a rush of air to enter the previously evacuated area inside the suction cup and temporarily produce a positive pressure. If there is fecal matter in this area, it can then be forced up through the mammary duct and into the gland. Even though the majority of environmental mastitis could be prevented by extra attention to the cleaning of both the cows' bedding and their teats prior to milking, such cleaning may not be always be achieved.

Contagious mastitis is most often caused by the Staph A. (Staphlococcus Aureus) bacteria or a myocoplasm organism (fungal type). This type of mastitis can be transferred from one cow to another via serial use of the milking machines between cows.

Both forms of mastitis can be treated with intra-mammary injection of antibiotics. This is usually injected by a dairy worker with the injection device inserted through the teat. However, e. coli is often an antibiotic-resistant organism.

There are also two categories or stages of the mastitis infection's manifestation: clinical and sub-clinical. Clinical involves obvious clinically observable signs or symptoms such as redness, soreness and swelling of one or more teats. 70% of the time, however, mastitis affects only one of a cow's teats and its associated mammary gland. Sub-clinical mastitis is a less severe form of the infection and does not result in clinical symptoms that are easily observable.

Somatic cells are generally white blood cells that produced by the immune system in response to infections, including mastitis. Therefore, the presence of somatic cells in milk is an indicator of mastitis in the teat. The severity of the infection can be assessed based on the concentration of somatic cells in milk. A somatic cell count of 200,000 cells/milliliter of milk is considered the threshold for determining the existence of a mastitis infection. 750,000 cells/ml is the U.S. legal limit allowable in drinking milk. That level is rarely realized in a bulk supply of milk, unless most of the cows in the pool are suffering from mastitis. The average somatic cell count for all milk produced for sale in the U.S. is 300,000 cells/ml. This indicates that mastitis is prevalent in our drinking milk.

As noted, the presence of somatic cells is an indicator of a condition of infection. The somatic cells are problematic because they affect the quality and taste of milk and shorten its shelf life, thereby having an economic impact.

Presently, a method for diagnosing mastitis is to determine a count of somatic cells in milk, by extracting a milk sample, transporting the sample to a testing laboratory and counting somatic cells. There is, presently, no system available for in-field, real-time testing of mastitis during milking, and therefore no system that provides immediate feedback to the dairy operator about the condition of a cow during milking.

Reflectance and transmittance spectroscopy can be used to identify particular substances or particular components of substances. Light is directed at or through a substance; the light that is either reflected by or transmitted through the substance is sensed and analyzed. The resulting spectral “signature”, correlated to known signatures, can be used to indicate properties of the substance or presence of substances.

### SUMMARY OF THE INVENTION

A device, system and method to diagnose mastitis in a dairy cow is presented. Light is employed to interrogate tissue or milk. More specifically, light is directed through or across either tissue or milk. The light that is transmitted through, or reflected by, the milk or tissue is sensed and measured, generating a spectral signature for the reflected or transmitted light. This signature, when compared to a calibration library containing data representing known healthy and known infected cows, reveals the presence or severity of a mastitis infection to enable diagnosis.

According to one embodiment of the invention, a device includes a test module mounted in or in conjunction with a portion of the milking apparatus. The module may be employed in the teat cup or in a portion of the milk conduit. The test module is coupled, via a light-transmitting cable, such as a fiber optic cable, to a spectrometer that includes a light source and light response receiver with associated optics. The spectrometer generates a light of known properties and receives the reflected or transmitted light, passing it through optics and converting the light response into a digital signal. The spectrometer is linked to a data analyzer to allow transmission of the signal representing the spectral signature of the light response therebetween. The analyzer applies mathematical algorithms that reference the calibration library to the signature to determine what the signature reveals about the properties of the tissue or milk tested.

The test module may be located in any of a number of positions with respect to the milking apparatus. For example, the test module may be located in the teat cup to be used to interrogate the udder tissue. Alternatively, the test module may be located in the milk conduit adjacent the teat cup, before the conduit from one teat cup joins the conduits from the other three cups on the same cow, to interrogate the milk from a particular quarter of the udder. In another embodiment, the test module may be located in the milk conduit downstream of the joining of the four conduits extending from the four teat cups, to test the overall quality of milk from a single cow. In yet another embodiment, the test module may be located downstream of the joining of the conduits coming from several cows, to test the quality of milk coming from the several cows. In yet another embodiment, the test module is placed in an active sampling line in parallel with the milk collection line.

In one embodiment, the data analyzer is linked for data communication with an alerting device, such as an alarm or display that may alert the dairy operator or dairy workers to the presence of mastitis, preferably during the milking operation so that corrective action can be taken before the affected milk is collected and pooled into the bulk collection.

In one embodiment, the data analyzer is linked to one or more personal computers, located in a back office of a milking establishment or at various locations in a milking parlor, coupled to a display and user input device to allow a dairy operator to view data collected by the system and device. In other embodiments, alternative electronic devices are used in place of or in addition to a personal computer, including a personal digital assistant (PDA), a cell phone, a media player device, or any other electronic device that can receive and display or relate digital information.

A system according to the present invention may further include a remote data center in data communication with one or more of the data analyzers located in milking operation sites. The data center includes data storage and processing capabilities. Through aggregation of data from multiple operations, the calibration library can be refined. Further, the data center may send input to the data analyzers in the field to update their software or math models or other operating instructions.

### BRIEF DESCRIPTION OF THE DRAWINGS

An exemplary version of a device, system and method for non-invasively diagnosing mastitis in a dairy cow is shown in the figures wherein like reference numerals refer to equivalent structure throughout, and wherein:

FIG. 1 is a side cross-sectional view of a device, shown employed on a cow udder, and a system incorporating the device, for non-invasively diagnosing mastitis;

FIG. 2 is a schematic diagram showing an alternate placement for the test modules of the device illustrated in FIG. 1;

FIG. 3 is a schematic diagram showing an alternate placement for the test modules of the device illustrated in FIG. 1;

FIG. 4 is a schematic diagram showing an alternate placement for the test modules of the device illustrated in FIG. 1;

FIG. 5 is a schematic diagram showing an alternate placement for the test modules of the device illustrated in FIG. 1;

FIG. 6 is a schematic diagram showing an alternate placement for the test modules of the device illustrated in FIG. 1;

FIG. 7 is a schematic diagram showing an alternate placement for a test module of the device of FIG. 1; and

FIG. 8 is a diagram schematically representing the components of a system for diagnosing mastitis in dairy cows and for collecting, processing and storing data collected by the system;

### DETAILED DESCRIPTION OF PREFERRED EMBODIMENT(S)

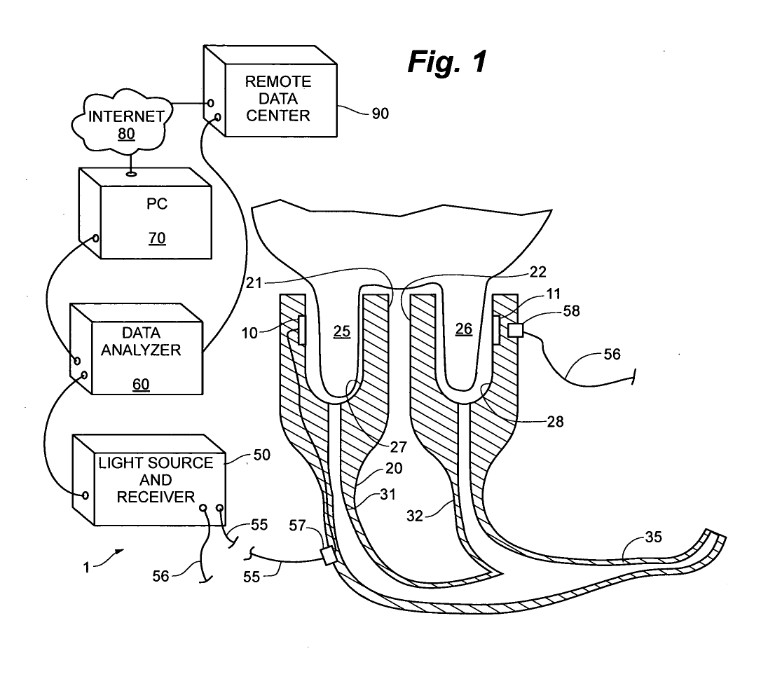

FIG. 1 shows a non-invasive mastitis diagnosis device 1. The device 1 includes at least one test module, typified by test modules 10 and 11, located in conjunction with an otherwise conventional milking apparatus 20 that includes teat cups exemplified by teat cups 21 and 22 for receiving a cow teat 25, 26 for milking. Each teat cup 21, 22 defines a space 27, 28 that exits to, is connected to, and is in fluid communication with a respective conduit 30, 31. The teat cups are in groups of four; two exemplary teat cups 21 and 22 are visible in FIG. 1. The conduits 30, 31, or “quarter lines”, for teat cups 21 and 22 (and the conduits associated with the other two teat cups not shown) intersect downstream of the teat cups 21, 22 and a single conduit 35, or “station line”, goes on to connect with conduits from other milking stations and eventually to empty into a collection tank (not shown).

A light source and receiver unit 50 or “light unit”, such as a spectrometer, is connected via a light transmitting cable 55, 56, such as a fiber optic cable, to respective test modules 10, 11. The test modules 10, 11 include a transparent window adjacent the tissue or substance to be interrogated, and the light transmitting cables 55, 56 are situated to direct light through the window and collect light directed back into the window (reflectance) or through a window located opposite the first (transmittance).

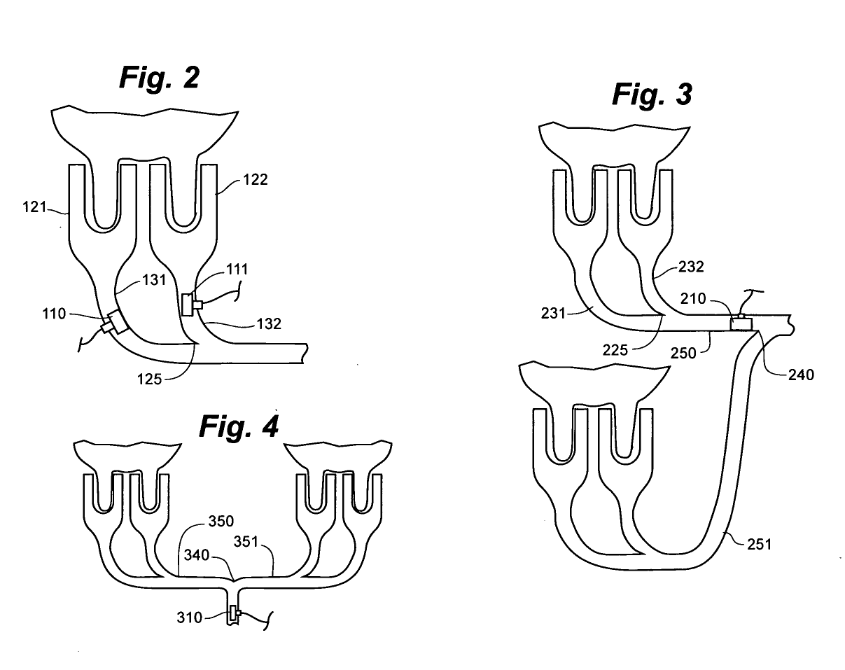

Cables 55, 56 exit the milking apparatus line via a connector 57, 58. Alternatively, separate spectrometers may be used for each test module. The light unit 50 includes optics and electronics for generating a light of given or predetermined properties to be transmitted via cables 55, 56 to the test modules 10, 11 and thereby directed through either milk or tissue. In FIG. 1, the modules 10, 11 are positioned with respect to the milk collection device to be adjacent the udder tissue. FIGS. 2-4, discussed below, place the modules at other locations.

With reference to FIG. 1, the light unit 50 further includes optics and electronics for sensing the light returned via cables 55, 56 from the test modules 10, 11 that is either transmitted through or reflected by the tissue or milk through which the test module transmits the light. The light unit 50 further includes electronics for interpreting the received light in relation to the known transmitted light to determine how much light was absorbed (in the case of transmittance mode) or reflected (in the case of reflection mode) by the substance tested (udder tissue for FIG. 1 embodiment; milk for FIGS. 2-4). The resulting light has a spectral signature that can be expressed in a number of ways, including intensity as a function of wavelength. The spectral signature is expressed by the light unit 50 as a digital signal.

The light unit 50 is coupled for data communication to a data analyzer 60 that receives the digital signal sent from the light unit 50. The analyzer 60 then applies predetermined mathematical operations or algorithms on the digital signal to cleanse the signal of noise and interpret the signal. This interpretation is made with reference to a calibration library. The calibration library is generated from historical cases of known infected milk or tissue and known mastitis-free milk or tissue. Subsequently collected samples are compared to those in the calibration library to draw a conclusion as to whether a sample indicates infection. Such a comparison may also reveal the severity of infection.

In the embodiment illustrated in FIG. 1, the data analyzer 60 is coupled for data transmission to a PC 70, coupled to a display and a user input device, that runs software or accesses a web site on the internet 80, or both, that provides a user interface for the dairy operator or worker to view data collected by the system. In alternative embodiments, the PC can be replaced or supplemented with other electronic devices including one or more handheld PDAs, cell phones, media devices, and the like.

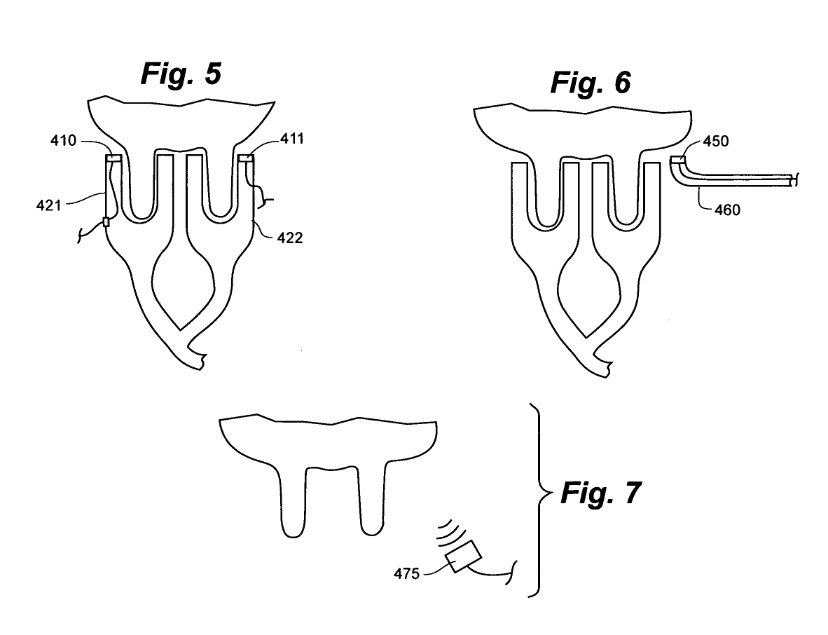

A data center 90 is coupled for data transmission to the data analyzer 60 and to the PC 70. The data center has data storage and processing capabilities and will be discussed more with respect to FIG. 5, below.

FIGS. 2-7 show alternate sites for placement of test modules. FIG. 2 shows test modules 110, 111 located downstream of the teat cups 121, 122 and upstream of the juncture 125 of the teat-specific conduits 131, 132.

FIG. 3 shows test module 210 located downstream of the juncture 225 of the teat-specific conduits 231, 232 and upstream of the juncture 240 of the cow-specific conduits 250, 251.

FIG. 4 shows test module 310 downstream of the juncture 340 of the cow-specific conduits 350, 351.

FIG. 5 shows test modules 410, 411 located on the upper surface of teat cups 421, 422, where “upper” as used here means the terminating end part of the teat cup that is adjacent and under the udder.

FIG. 6 shows a test module 450 located on a robotic arm 460 that is coupled to mechanisms and electronic controls for moving the robotic arm 460 such that test module 450 is located adjacent the cow's udder. The arm is moved into and out of testing position to accommodate a cow moving into and out of the milking station.

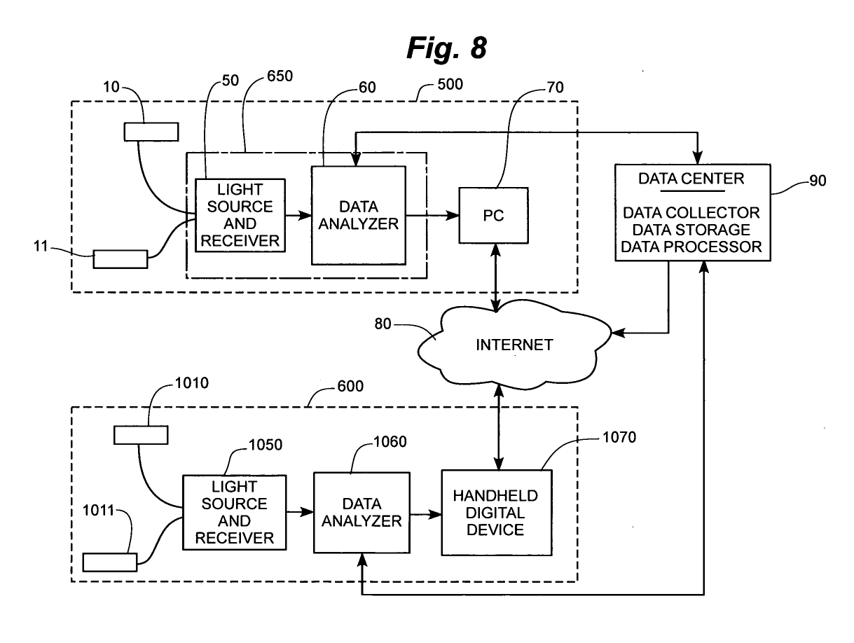

FIG. 7 shows a test module 475 positioned remotely from the udder during testing. In this embodiment, the test module 475 focuses emitted light on the udder from a distance, such that the test module 475 need not be brought into contact with or adjacent the cow's udder or teat or milk.

FIG. 8 shows schematically how the system is implemented across multiple dairy operations, exemplified by two operations 500, 600, though it should be understood that any number of operations might be included. Second operation 600 includes components similar to those of operation 500, with the following reference numbers: light source and receiver 1050, data analyzer 1060, handheld digital device 1070. In one embodiment, light unit 50 is housed in a unit separate from data analyzer 60; in an alternate embodiment, these components may be housed in a single unit 650. The data center 90 is linked for data communication with data analyzers 60, 1060 at multiple locations.

The light unit 50, 1050 may accommodate one or more test modules. In other words, there may be one unit per milking line, or the unit may include multiple inputs and outputs to operate a test module on more than one quarter of an individual milking station or to more than one milking station. If an active sampling line were employed, it may be particularly feasible for one light unit to operate more than one test module.

The data analyzer 60, 1060 may be located at the dairy operation site, as suggested in FIG. 5; in an alternative embodiment, the analyzer may be remotely located offsite, such as being incorporated with the data center 90. As noted above, in another embodiment, again suggested in FIG. 8, the analyzer 60 may be incorporated in a housing with the light unit 50.

The test modules and light units may be located in any of a number of locations within a milking operation, including but not limited to: at the individual milking stations and in an area designated for infected cows to monitor their disease progress. In milking stanchions providing a recess below or otherwise out of the area the cow inhabits, the light unit may be positioned within the recess.

In one embodiment of the system, cows are uniquely identified and their each cow's test data is stored in association with her ID. In preferred embodiments, an identification tag, such as an implanted radio-frequency (“RF”) tag is used and a device for automatically reading the ID at the individual milking station, or en route thereto or therefrom, and submitting the ID to the data analyzer is employed. By storing a cow's test data with her ID, it is possible to track the cow's health over time and draw conclusions from observed changes in her readings. Similarly, it is possible to compare readings amongst her quarters to observe any difference that may indicate an infection in one quarter before it spreads to other quarters.

Collecting and storing data from one user over a period of time or from a number of users of the system allows for the building of a large data set that can be used to refine the calibration library used by the system.

The device, system and method described herein can be applied to measure somatic cells in milk or some other correlate of mastitis. It may employ transmittance or reflectance light spectroscopy, where the light used may fall within any portion of the electromagnetic spectrum, including visible, infra-red, near infra-red, and ultraviolet frequency ranges, or may be laser light. The test module may be detachable and disposable or may be more permanent or incorporated into capital equipment. The test module may provide real-time continuous reading to the spectrometer, or it may instead simply trigger an alerting device, such as an audio or visual signal for the milking operator. The test module may, when it detects sub-clinical or clinical levels of mastitis, provide information and/or effect an alarm or other notification, thereby providing a definitive signal to the operator. In one embodiment, the test module is rendered inoperative when mastitis has been detected, thereby requiring replacement of the module.

Throughout, “linked for data communication”, “coupled for data communication”, “linked for data transmission” and “coupled for data transmission” mean any manner in which two electronic devices share or convey to one another digital information. This includes, for example, via hard-wire connection, LAN, WAN, the internet, cable, and wireless communication via BlueTooth or satellite.

This device, system and method have been described as being dedicated in purpose to detecting mastitis in cows; it should be understood that it may also or instead be used to identify other properties of milk or tissue in cows or other animals.

Although an illustrative version of the device, system and method is shown, it should be clear that many modifications to the device, system and method may be made without departing from the scope of the invention.

I claim:

1. A device for non-invasively diagnosing mastitis in a dairy cow, comprising:
a) means for milk collection, said means including a teat cup coupled to and in fluid communication with a conduit extending therefrom;
b) a light unit;
c) a test module connected to said milk collection means; and
d) a light-transmitting cable extending between said test module and said light unit.

2. A device according to claim 1, wherein said light-transmitting cable is a fiber optic cable.

3. A device according to claim 1, wherein said light unit produces light in the visible frequency range.

4. A device according to claim 1, wherein said light unit produces light in the infrared frequency range.

5. A device according to claim 1, wherein said light unit produces light in the near infra-red frequency range.

6. A device according to claim 1, wherein said light unit produces laser light.

7. A device according to claim 1 wherein said test module is located in said teat cup.

8. A device according to claim 1 wherein said test module is located in said conduit.

9. A device according to claim 1 wherein said milk collection mean includes four teat cups coupled to said conduit and wherein said device include four test modules, with one test module located in each of said teat cups.

10. A device according to claim 1 wherein said test module is located at the terminating end of said teat cups adjacent the udder.

11. A device for non-invasively diagnosing mastitis in a dairy cow, comprising:
a) a light unit;
b) a test module carried on a robotic arm; and
c) a light-transmitting cable extending between said test module and said light unit.

12. A system for non-invasively diagnosing mastitis in a dairy cow, comprising:
a) means for milk collection, said means including a teat cup and a conduit extending therefrom;
b) a light unit;
c) a test module connected to said milk collection means;
d) a light-transmitting cable extending between said test module and said spectrometer; and
e) a data analyzer linked to said light unit for data transmission therebetween.

13. A system according to claim 11, further comprising an indicator coupled to said data analyzer.

14. A system according to claim 13, further comprising:
f) a computer connected to said data analyzer for data communication therebetween.

15. A system according to claim 14, further comprising:
g) a display connected to said computer for data communication therebetween.

16. A system according to claim 12, further comprising:
f) a remote data center linked to said data analyzer for data transmission therebetween.

17. A method for non-invasively diagnosing mastitis in a dairy cow, comprising the steps of:
a) providing a device having:
i) means for milk collection, said means including a teat cup and a conduit extending therefrom;
ii) a light unit;
iii) a test module connected to said milk collection means; and
iv) a light-transmitting cable extending between said test module and said light unit; and
v) a data analyzer linked to said light unit for data transmission therebetween;
b) connecting said teat cup to a teat of a cow to be milked and commencing milking;
c) activating said spectrometer to emit light from said test module through milk flowing through said milk collection means and said test module receiving a reflectance or transmittance response and transmitting the responsive light to said light unit; and
d) passing data reflecting said response to said data analyzer.

18. A method for non-invasively diagnosing mastitis in a dairy cow, comprising the steps of:
a) providing a device having:
i) means for milk collection, said means including a teat cup and a conduit extending therefrom;
ii) a light unit;
iii) a test module connected to said milk collection means; and
iv) a light-transmitting cable extending between said test module and said light unit; and
v) a data analyzer linked to said spectrometer for data transmission therebetween;
b) connecting said teat cup to a teat of a cow to be milked and commencing milking;
c) activating said spectrometer to emit light from said test module through udder tissue and said test module receiving a reflectance or transmittance response and transmitting the responsive light to said light unit;
d) passing data reflecting said response to said data analyzer.
